(19) United States
(12) Patent Application Publication
(10) Pub. No.: US 2023/0384120 A1
(43) Pub. Date: Nov. 30, 2023

(54) Method and Apparatus for Updating High-Precision Map

(71) Applicant: Beijing Co Wheels Technology Co., Ltd, Beijing (CN)

(72) Inventors: Changshi Fan, Beijing (CN); Wei Wu, Beijing (CN)

(21) Appl. No.: 18/255,156

(22) PCT Filed: Oct. 14, 2021
(86) PCT No.: PCT/CN2021/123852

§ 371 Date: May 31, 2023

(30) Foreign Application Priority Data
Dec. 1, 2020 (CN) 202011387389.1

(51) Int. Cl. G01C 21/00; G06T 7/70; G06V 20/58

(52) U.S. Cl. CPC G01C 21/3841; G06T 7/70; G06V 20/58; G06T 2207/30252; G01C 21/3848; G06T 2207/10016; G01C 21/3822

(57) ABSTRACT

A method for updating a high-precision map includes: acquiring running data corresponding to target vehicles, wherein the running data corresponding to the target vehicles includes: running route information corresponding to each of the target vehicles, a running video and a camera calibration file corresponding to the target vehicle; determining position information of target road elements collected by each of the target vehicles according to the running route information, the running video and the camera calibration file corresponding to the target vehicle, wherein the position information of each of the target road elements is position information of a target lane line or a target road identifier in the target road section in the high-precision map; and updating the high-precision map according to the position information of the target road elements collected by each of the target vehicles.

### CROSS-REFERENCE TO RELATED APPLICATION

This application is a U.S. National Stage Application of International Application No. PCT/CN2021/123852, filed Oct. 14, 2021, which is based upon and claims priority to Chinese Patent Application No. 202011387389.1, filed Dec. 1, 2020, the entire contents of which are incorporated herein by reference.

### FIELD

The present disclosure relates to the technical field of high-precision maps, and more particularly to a method and apparatus for updating a high-precision map.

### BACKGROUND

With the continuous development of science and technology, automatic driving technology has also developed rapidly. Among others, a high-precision map is the basis for realizing automatic driving, which specifically includes road identifiers, lane lines, traffic rules and other elements for navigation of autonomous driving vehicles. Due to road construction and other reasons, positions of the road identifiers and the lane lines will be changed. For this, in order to ensure the driving safety of automatic driving vehicles, the positions of the road identifiers and the lane lines in the high-precision map needs to be updated in time.

At present, the positions of the road identifiers and the lane lines in the high-precision map are updated using a centralized drawing method, that is, a manufacturer of the high-precision map collects position information of the road identifiers and the lane lines in the target road section through self-modified data acquiring vehicles, and then updates the high-precision map according to the position information of the road identifiers and the lane lines collected by the data acquiring vehicles. However, due to the high cost for modifying the data acquiring vehicles, the cost for updating the high-precision map is also high.

### SUMMARY

In a first aspect, embodiments of the present disclosure provide a method for updating a high-precision map. The method includes:

acquiring running data corresponding to target vehicles, in which the running data corresponding to the target vehicles is collected by the target vehicles when each of the target vehicle passes through a target road section within a target time period, and the running data corresponding to the target vehicles comprises: running route information corresponding to each of the target vehicles, a running video and a camera calibration file corresponding to the target vehicle;

determining position information of target road elements collected by each of the target vehicles according to the running route information, the running video and the camera calibration file corresponding to the target vehicle, in which the position information of each of the target road elements is position information of a target lane line or a target road identifier in the target road section in the high-precision map; and

updating the high-precision map according to the position information of the target road elements collected by each of the target vehicles.

In another aspect, embodiments of the present disclosure provide a storage medium having stored therein programs that, when executed, control a device in which the storage medium is disposed to execute the method for updating a high-precision map as described in the first aspect.

In another aspect, embodiments of the present disclosure provide an apparatus for updating a high-precision map. The apparatus includes: a storage medium; and one or more processors coupled to the storage medium. The one or more processors are configured to execute program instructions stored in the storage medium, and the program instructions, when executed, cause the method for updating a high-precision map as described in the first aspect to be performed.

### BRIEF DESCRIPTION OF THE DRAWINGS

Above and other aspects, characteristics and advantages of embodiments of the present disclosure will become easy to understand from the following descriptions with reference to the drawings. In the drawings, several embodiments are provided for illustrating the present disclosure, which shall not be construed to limit the present disclosure. The same or corresponding parts are denoted by same or corresponding reference numerals.

FIG. 1 is a schematic flowchart for illustrating a method for updating a high-precision map according to an embodiment of the present disclosure;

FIG. 2 is a schematic flowchart for illustrating a method for updating a high-precision map according to another embodiment of the present disclosure;

FIG. 3 is a schematic block diagram for illustrating an apparatus for updating a high-precision map according to an embodiment of the present disclosure; and

FIG. 4 is a schematic block diagram for illustrating an apparatus for updating a high-precision map according to another embodiment of the present disclosure.

### DETAILED DESCRIPTION

Embodiments of the present disclosure will be described in more detail below with reference to the accompanying drawings. Although several embodiments of the present disclosure are shown in the accompanying drawings, it should be understood that the present disclosure can be implemented in various forms and shall not be limited by embodiments described herein. On the contrary, these embodiments are provided to enable those skilled in the art to better understand the present disclosure and its scope.

It should be noted that, unless specified otherwise, technical terms or scientific terms used in present disclosure have the general meaning understood by those skilled in the art to which the present disclosure belongs.

Embodiments of the present disclosure provide a method and apparatus for updating a high-precision map, which aim to reduce the cost for updating the high-precision map, on the basis of ensuring positions of road identifiers and lane lines in the high-precision map to be updated in time.

In a first aspect, embodiments of the present disclosure provide a method for updating a high-precision map. The method includes:

acquiring running data corresponding to target vehicles, in which the running data corresponding to the target vehicles is collected by the target vehicles when each of the target vehicle passes through a target road section within a target time period, and the running data corresponding to the target vehicles comprises: running route information corresponding to each of the target vehicles, a running video and a camera calibration file corresponding to the target vehicle;

determining position information of target road elements collected by each of the target vehicles according to the running route information, the running video and the camera calibration file corresponding to the target vehicle, in which the position information of each of the target road elements is position information of a target lane line or a target road identifier in the target road section in the high-precision map; and

updating the high-precision map according to the position information of the target road elements collected by each of the target vehicles.

In some embodiments, the determining the position information of the target road elements collected by each of the target vehicles according to the running route information, the running video and the camera calibration file corresponding to the target vehicle includes:

extracting frames of running images from the running video corresponding to the target vehicle, in which each of the frames of running images includes a target road element, and the target road element is a target lane line or a target road identifier;

determining position information corresponding to each of the frames of running images according to the running video and the running route information corresponding to the target vehicle, in which the position information corresponding to each of the frames of running images is position information of the target vehicle in the high-precision map when the target vehicle shoots the running image; and

determining the position information of the target road elements collected by the target vehicle according to the camera calibration file corresponding to the target vehicle, the frames of running images and the position information corresponding to each of the frames of running images.

In some embodiments, the determining the position information of the target road elements collected by the target vehicle according to the camera calibration file corresponding to the target vehicle, the frames of running images and the position information corresponding to each of the frames of running images includes:

determining a first position corresponding to each of the target road elements according to a preset perceptual recognition algorithm and the frames of running images, in which the first position corresponding to each of the target road elements is a position of the target road element in the respective running image;

determining a second position corresponding to each of the target road elements according to the first position corresponding to the target road element and the camera calibration file, in which the second position corresponding to each of the target road elements is a position of the target road element relative to the target vehicle; and

determining the position information of the target road elements collected by the target vehicle according to the second position corresponding to each of the target road elements and the position information corresponding to each of the frames of running images.

In some embodiments, the position information of the target road elements collected by each of the target vehicles is position information of target lane lines in the target road section in the high-precision map, and the updating the high-precision map according to the position information of the target road elements collected by each of the target vehicles includes:

grouping position information of target road elements corresponding to each of the target lane lines into sets to gather position information of target road elements at a same position corresponding to the target lane line into a same set;

determining, from the sets corresponding to each of the target lane lines, position information of target road elements in a set which includes the largest number of set elements as a to-be-used position corresponding to the target lane line; and

updating the high-precision map using the to-be-used position corresponding to each of the target lane lines.

In some embodiments, the position information of the target road elements collected by each of the target vehicles is position information of target lane lines in the target road section in the high-precision map, and the updating the high-precision map according to the position information of the target road elements collected by each of the target vehicles includes:

acquiring an original position of each of the target lane lines from the high-precision map; comparing the position information of the target road elements corresponding to each of the target lane lines with the original position of the target lane line to acquire deviated positions corresponding to the target lane line;

determining a to-be-used position corresponding to the target lane line according to the deviated positions corresponding to the target lane line when a proportion of the number of the deviated positions corresponding to the target lane line to the number of pieces of position information of the target road elements corresponding to the target lane line is greater than a preset proportion threshold; and

updating the high-precision map using the to-be-used position corresponding to the target lane line.

In some embodiments, the position information of the target road elements collected by each of the target vehicles is position information of target load identifiers in the target road section in the high-precision map, and the updating the high-precision map according to the position information of the target road elements collected by each of the target vehicles includes:

grouping position information of target road elements corresponding to each of the target load identifiers into sets to gather position information of target road elements at a same position corresponding to the target load identifier into a same set;

determining, from the sets corresponding to each of the target load identifiers, position information of target road elements in a set which includes the largest number of set elements as a to-be-used position corresponding to the target load identifier; and

updating the high-precision map using the to-be-used position corresponding to each of the target load identifiers.

In some embodiments, the position information of the target road elements collected by each of the target vehicles is position information of target road identifiers in the target road section in the high-precision map, and the updating the high-precision map according to the position information of the target road elements collected by each of the target vehicles includes:

acquiring an original position of each of the target road identifiers from the high-precision map;

comparing the position information of the target road elements corresponding to each of the target road identifiers with the original position of the target road identifier to acquire deviated positions corresponding to the target road identifier;

determining a to-be-used position corresponding to the target road identifier according to the deviated positions corresponding to the target road identifier when a proportion of the number of the deviated positions corresponding to the target road identifier to the number of pieces of position information of the target road elements corresponding to the target road identifier is greater than a preset proportion threshold; and

updating the high-precision map using the to-be-used position corresponding to the target road identifier.

In some embodiments, before acquiring the running data corresponding to the target vehicles, the method further includes:

receiving running data sent by each of the target vehicles; and storing the running data sent by each of the target vehicles into a local storage space.

In some embodiments, each of the target vehicles is provided with a preset camera and a GPS sensor.

In a second aspect, embodiments of the present disclosure provide an apparatus for updating a high-precision map. The apparatus includes:

an acquiring unit, configured to acquire running data corresponding to target vehicles, in which the running data corresponding to the target vehicles is collected by the target vehicles when each of the target vehicle passes through a target road section within a target time period, and the running data corresponding to the target vehicles includes: running route information corresponding to each of the target vehicles, a running video and a camera calibration file corresponding to the target vehicle;

a determining unit, configured to determine position information of target road elements collected by each of the target vehicles according to the running route information, the running video and the camera calibration file corresponding to the target vehicle, in which the position information of each of the target road elements is position information of a target lane line or a target road identifier in the target road section in the high-precision map; and

an updating unit, configured to update the high-precision map according to the position information of the target road elements collected by each of the target vehicles.

In some embodiments, the determining unit includes:

an extracting module, configured to extract frames of running images from the running video corresponding to the target vehicle, in which each of the frames of running images includes a target road element, and the target road element is a target lane line or a target road identifier;

a first determining module, configured to determine position information corresponding to each of the frames of running images according to the running video and the running route information corresponding to the target vehicle, in which the position information corresponding to each of the frames of running images is position information of the target vehicle in the high-precision map when the target vehicle shoots the running image; and

a second determining module, configured to determine the position information of the target road elements collected by the target vehicle according to the camera calibration file corresponding to the target vehicle, the frames of running images and the position information corresponding to each of the frames of running images.

In some embodiments, the second determining module includes:

a first determining sub-module, configured to determine a first position corresponding to each of the target road elements according to a preset perceptual recognition algorithm and the frames of running images, in which the first position corresponding to each of the target road elements is a position of the target road element in the respective running image;

a second determining sub-module, configured to determine a second position corresponding to each of the target road elements according to the first position corresponding to the target road element and the camera calibration file, in which the second position corresponding to each of the target road elements is a position of the target road element relative to the target vehicle; and a third determining sub-module, configured to determine the position information of the target road elements collected by the target vehicle according to the second position corresponding to each of the target road elements and the position information corresponding to each of the frames of running images.

In some embodiments, the position information of the target road elements collected by each of the target vehicles is position information of target lane lines in the target road section in the high-precision map, and the updating unit includes:

a first grouping module, configured to group position information of target road elements corresponding to each of the target lane lines into sets to gather position information of target road elements at a same position corresponding to the target lane line into a same set;

a third determining module, configured to determine, from the sets corresponding to each of the target lane lines, position information of target road elements in a set which includes the largest number of set elements as a to-be-used position corresponding to the target lane line; and

a first updating module, configured to update the high-precision map using the to-be-used position corresponding to each of the target lane lines.

In some embodiments, the position information of the target road elements collected by each of the target vehicles is position information of target lane lines in the target road section in the high-precision map, and the updating unit includes:

a first acquiring module, configured to acquire an original position of each of the target lane lines from the high-precision map;

a first comparing module, configured to compare the position information of the target road elements corresponding to each of the target lane lines with the original position of the target lane line to acquire deviated positions corresponding to the target lane line;

a fourth determining module, configured to determine a to-be-used position corresponding to the target lane line according to the deviated positions corresponding to the target lane line when a proportion of the number of the deviated positions corresponding to the target lane line to the number of pieces of position information of the target road elements corresponding to the target lane line is greater than a preset proportion threshold; and

a second updating module, configured to update the high-precision map using the to-be-used position corresponding to the target lane line.

In some embodiments, the position information of the target road elements collected by each of the target vehicles is position information of target load identifiers in the target road section in the high-precision map, and the updating unit includes:

a second grouping module, configured to group position information of target road elements corresponding to each of the target load identifiers into sets to gather position information of target road elements at a same position corresponding to the target load identifier into a same set;

a fifth determining module, configured to determine, from the sets corresponding to each of the target load identifiers, position information of target road elements in a set which includes the largest number of set elements as a to-be-used position corresponding to the target load identifier; and

a third updating module, configured to update the high-precision map using the to-be-used position corresponding to each of the target load identifiers.

In some embodiments, the position information of the target road elements collected by each of the target vehicles is position information of target road identifiers in the target road section in the high-precision map, and the updating unit includes:

a second acquiring module, configured to acquire an original position of each of the target road identifiers from the high-precision map;

a second comparing module, configured to compare the position information of the target road elements corresponding to each of the target road identifiers with the original position of the target road identifier to acquire deviated positions corresponding to the target road identifier;

a sixth determining module, configured to determine a to-be-used position corresponding to the target road identifier according to the deviated positions corresponding to the target road identifier when a proportion of the number of the deviated positions corresponding to the target road identifier to the number of pieces of position information of the target road elements corresponding to the target road identifier is greater than a preset proportion threshold; and

a fourth updating module, configured to update the high-precision map using the to-be-used position corresponding to the target road identifier.

In some embodiments, the apparatus further includes:

a receiving unit, configured to receive running data sent by each of the target vehicles before the acquiring unit acquires the running data corresponding to the target vehicles; and

a storing unit, configured to store the running data sent by each of the target vehicles into a local storage space.

In some embodiments, each of the target vehicles is provided with a preset camera and a GPS sensor.

In a third aspect, embodiments of the present disclosure provide a storage medium having stored therein programs that, when executed, control a device in which the storage medium is disposed to execute the method for updating a high-precision map as described in the first aspect.

In a fourth aspect, embodiments of the present disclosure provide an apparatus for updating a high-precision map. The apparatus includes: a storage medium; and one or more processors coupled to the storage medium. The one or more processors are configured to execute program instructions stored in the storage medium, and the program instructions, when executed, cause the method for updating a high-precision map as described in the first aspect to be performed.

Embodiments of the present disclosure provide a method and apparatus for updating a high-precision map. In contrast to updating positions of road identifies and lane lines in a high-precision map by a centralized drawing method in the related art, embodiments of the present disclosure are able to acquire, at a cloud server, the running data (including such as the running videos shot by preset the cameras, the running route information recorded by the GPS sensors, and the camera calibration files corresponding to the respective preset cameras) collected by the target vehicles when each of the target vehicle passes through the target road section within the target time period; determine by the cloud server the position information of target road elements corresponding to each target lane line and/or each target load identifier collected by each of the target vehicles according to the running route information, the running video and the camera calibration file collected by the target vehicle; and update by the cloud server the high-precision map according to the position information of the target road elements corresponding to each target lane line and/or each target load identifier collected by each of the target vehicles. Since each target vehicle is an ordinary vehicle equipped with a preset camera and a GPS sensor, and the target vehicle, after collecting the running data, will upload the running data to the cloud server, the cloud server can ensure that the positions of the road identifier and the lane line in the high-precision map are updated in time, and at the same time, the cost for updating the high-precision map is reduced.

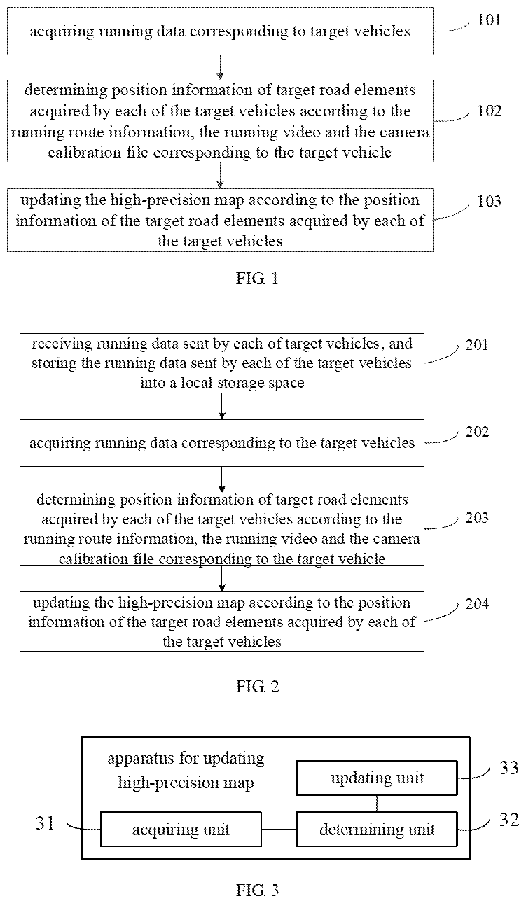

Embodiments of the present disclosure provide a method for updating a high-precision map. As shown in FIG. 1, the method includes the following steps.

At step 101, running data corresponding to target vehicles are acquired.

Each of the target vehicles is a vehicle which passes through a target road section within a target time period. Specifically, the target vehicle is an ordinary vehicle equipped with a preset camera and a GPS sensor. The running data corresponding to the target vehicles is collected when each of the target vehicle passes through the target road section within the target time period. Specifically, the running data corresponding to the target vehicles includes: running route information corresponding to each of the target vehicles, a running video and a camera calibration file corresponding to the target vehicle. The target road section includes target lane lines and/or target load identifiers.

In embodiments of the present disclosure, an executive body of each step is a cloud server. For any target vehicle, it will send the running data (including the running video shot by the preset camera, the running route information recorded by the GPS sensor, and the camera calibration file corresponding to the preset camera) collected when it passes through the target road section within the target time period to the cloud server, such that when a preset updating time is reached, the cloud server is able to acquire the running data collected by the target vehicles when each of the target vehicle passes through the target road section within the target time period. The preset updating time may be, but not limited to, 00:00:00 or 12:00:00 for every day, and the target time period may be, but not limited to, 24 hours, 48 hours, 36 hours and the like before the preset updating time.

At step 102, position information of target road elements collected by each of the target vehicles is determined according to the running route information, the running video and the camera calibration file corresponding to the target vehicle.

The position information of each of the target road elements is position information of a target lane line or a target road identifier in the target road section in the high-precision map.

In embodiments of the present disclosure, after acquiring the running data collected by the target vehicles when each of the target vehicle passes through the target road section within the target time period, the cloud server is able to determine the position information of the target road elements collected by each of the target vehicles according to the running data (the running route information, the running video and the camera calibration file) collected by the target vehicle, i.e., to determine the position information of the target road elements corresponding to each target lane line and/or each target load identifier collected by each of the target vehicles according to the running route information, the running video and the camera calibration file collected by the target vehicle.

At step 103, the high-precision map is updated according to the position information of the target road elements collected by each of the target vehicles.

In embodiments of the present disclosure, after determining the position information of the target road elements collected by each of the target vehicles according to the running data (the running route information, the running video and the camera calibration file) collected by the target vehicle, the cloud server is able to update the high-precision map according to the position information of the target road elements collected by each of the target vehicles, i.e., to update the high-precision map according to the position information of the target road elements corresponding to each target lane line and/or each target load identifier collected by each of the target vehicles.

Embodiments of the present disclosure provide a method for updating a high-precision map. In contrast to updating positions of road identifies and lane lines in a high-precision map by a centralized drawing method in the related art, embodiments of the present disclosure are able to acquire, at a cloud server, the running data (including such as the running videos shot by preset the cameras, the running route information recorded by the GPS sensors, and the camera calibration files corresponding to the respective preset cameras) collected by the target vehicles when each of the target vehicle passes through the target road section within the target time period; determine by the cloud server the position information of target road elements corresponding to each target lane line and/or each target load identifier collected by each of the target vehicles according to the running route information, the running video and the camera calibration file collected by the target vehicle; and update by the cloud server the high-precision map according to the position information of the target road elements corresponding to each target lane line and/or each target load identifier collected by each of the target vehicles. Since each target vehicle is an ordinary vehicle equipped with a preset camera and a GPS sensor, and the target vehicle, after collecting the running data, will upload the running data to the cloud server, the cloud server can ensure that the positions of the road identifier and the lane line in the high-precision map are updated in time, and at the same time, the cost for updating the high-precision map is reduced.

In the following, for illustrating the present disclosure in more detail, embodiments of the present disclosure provide another method for updating a high-precision map. As shown in FIG. 2, the method includes the following steps.

At step 201, running data sent by each of the target vehicles is received and stored into a local storage space.

In embodiments of the present disclosure, each of the target vehicles will send the running data (including the running video shot by the preset camera, the running route information recorded by the GPS sensor, and the camera calibration file corresponding to the preset camera) collected when it passes through the target road section within the target time period to the cloud server; and the cloud server, after receiving the running data sent by each of the target vehicles, will store the running data sent by each of the target vehicles into the local storage space, such that when the preset updating time is reached, the cloud server is able to acquire, from the local storage space, the running data collected by each of the target vehicles when it passes through the target road section within the target time period.

At step 202, the running data corresponding to target vehicles is acquired.

Regarding the step 202 of acquiring the running data corresponding to the target vehicles, reference can be made to the relevant parts described above with respect to FIG. 1, which will not be elaborated herein.

At step 203, position information of target road elements collected by each of the target vehicles is determined according to the running route information, the running video and the camera calibration file corresponding to the target vehicle.

In embodiments of the present disclosure, after acquiring the running data corresponding to target vehicles collected when each of the target vehicle passes through the target road section within the target time period, the cloud server is able to determine the position information of the target road elements collected by each of the target vehicles according to the running data (the running route information, the running video and the camera calibration file) collected by the target vehicle.

Specifically, in embodiments of the present disclosure, for any target vehicle, the cloud server may determine the position information of the target road elements collected by the target vehicle according to the running route information, the running video and the camera calibration file corresponding to the target vehicle through the following manner.

(1) Frames of running images are extracted from the running video corresponding to the target vehicle.

The running video corresponding to the target vehicle consists of frames of images, the running image corresponding to the target vehicle specifically is an image including a target road element, and the target road element is a target lane line or a target road identifier in the target road section.

(2) Position information corresponding to each of the frames of running images is determined according to the running video and the running route information corresponding to the target vehicle.

The position information corresponding to any running image is position information of the target vehicle in the high-precision map when the target vehicle shoots the running image.

In embodiments of the present disclosure, after extracting the frames of running images from the running video corresponding to the target vehicle, the cloud server is able to determine the position information corresponding to each of the frames of running images according to the running video and the running route information corresponding to the target vehicle. Specifically, in this step, the cloud server may align a timestamp sequence corresponding to the running route information with the frames of images included in the running video to determine position information corresponding to each of the frames of images included in the running video, and determine the position information corresponding to each of the frames of running images according to the position information corresponding to each of the frames of images included in the running video. The present disclosure is not limited thereto.

(3) The position information of the target road elements collected by the target vehicle is determined according to the camera calibration file corresponding to the target vehicle, the frames of running images and the position information corresponding to each of the frames of running images.

In embodiments of the present disclosure, after determining the position information corresponding to each of the frames of running images according to the running video and the running route information corresponding to the target vehicle, the cloud server is able to determine the position information of the target road elements collected by the target vehicle according to the camera calibration file corresponding to the target vehicle, the frames of running images and the position information corresponding to each of the frames of running images.

Specifically, in this step, the cloud server may determine the position information of the target road elements collected by the target vehicle according to the camera calibration file corresponding to the target vehicle, the frames of running images and the position information corresponding to each of the frames of running images through the following manner. Firstly, a first position corresponding to each of the target road elements is determined according to a preset perceptual recognition algorithm and the frames of running images. The first position corresponding to each of the target road elements is a position of the target road element in the respective running image, and the preset perceptual recognition algorithm may be any existing deep learning recognition algorithm, which is not specifically limited in embodiments of the present disclosure. Secondly, a second position corresponding to each of the target road elements is determined according to the first position corresponding to the target road element and the camera calibration file. The second position corresponding to each of the target road elements is a position of the target road element relative to the target vehicle, and the camera calibration file includes an internal reference calibration file and an external reference calibration file. A position of the target road element relative to the preset camera of the target vehicle may be determined according to the first position corresponding to the target road element and the internal reference calibration file, and the second position corresponding to target road element may be determined according to the position of the target road element relative to the preset camera of the target vehicle and the external reference calibration file. Finally, the position information of the target road elements collected by the target vehicle is determined according to the second position corresponding to each of the target road elements and the position information corresponding to each of the frames of running images.

At step 204, the high-precision map is updated according to the position information of the target road elements collected by each of the target vehicles.

In embodiments of the present disclosure, after determining the position information of the target road elements collected by each of the target vehicles according to the running data (the running route information, the running video and the camera calibration file) collected by the target vehicle, the cloud server is able to update the high-precision map according to the position information of the target road elements collected by each of the target vehicles. In the following, detailed description will be made on how the cloud server updates the high-precision map according to the position information of the target road elements collected by each of the target vehicles.

(1) When the position information of the target road elements collected by each of the target vehicles is position information of target lane lines in the target road section in the high-precision map, the cloud server may update the high-precision map according to the position information of the target road elements collected by each of the target vehicles through the following two manners.

The first manner includes the following steps. Firstly, position information of target road elements corresponding to each of the target lane lines is grouped into sets to gather position information of target road elements at a same position corresponding to the target lane line into a same set. Secondly, from the sets corresponding to each of the target lane lines, position information of target road elements in a set which includes the largest number of set elements is determined as a to-be-used position corresponding to the target lane line. Finally, the high-precision map is updated using the to-be-used position corresponding to each of the target lane lines.

The second manner includes the following steps. Firstly, an original position of each of the target lane lines is acquired from the high-precision map. The original position of each of the target lane lines is position information of the target lane line recorded in the high-precision map. Secondly, the position information of the target road elements corresponding to each of the target lane lines is compared with the original position of the target lane line to acquire deviated positions corresponding to the target lane line. It should be illustrated that, if the position information of a certain target road element corresponding to a certain target lane line is the same as the original position of the target lane line, it is determined that the position information of the target road element is an un-deviated position (i.e., a position without deviation) corresponding to the target lane line; and if the position information of a certain target road element corresponding to a certain target lane line is different from the original position of the target lane line, it is determined that the position information of the target road element is a deviated position corresponding to the target lane line. For any target lane line, if a proportion of the number of the deviated positions corresponding to the target lane line to the number of pieces of position information of the target road elements corresponding to the target lane line is greater than a preset proportion threshold, a to-be-used position corresponding to the target lane line is determined according to the deviated positions corresponding to the target lane line. Specifically, an average value of the deviated positions corresponding to the target lane line may be determined as the to-be-used position corresponding to the target lane line, but the present disclosure is not limited thereto. The preset proportion threshold may be, but not limited to, 30%, 40%, 50% and so on. Finally, after acquiring the to-be-used position corresponding to a certain target lane line, the high-precision map is updated using the to-be-used position corresponding to the target lane line.

(2) When the position information of the target road elements collected by each of the target vehicles is position information of target load identifiers in the target road section in the high-precision map, the cloud server may update the high-precision map according to the position information of the target road elements collected by each of the target vehicles through the following two manners.

The first manner includes the following steps. Firstly, position information of target road elements corresponding to each of the target load identifiers is grouped into sets to gather position information of target road elements at a same position corresponding to the target load identifier into a same set. Secondly, from the sets corresponding to each of the target load identifiers, position information of target road elements in a set which includes the largest number of set elements is determined as a to-be-used position corresponding to the target load identifier. Finally, the high-precision map is updated using the to-be-used position corresponding to each of the target load identifiers.

The second manner includes the following steps. Firstly, an original position of each of the target load identifiers is acquired from the high-precision map. The original position of each of the target load identifiers is position information of the target load identifier recorded in the high-precision map. Secondly, the position information of the target road elements corresponding to each of the target load identifiers is compared with the original position of the target load identifier to acquire deviated positions corresponding to the target load identifier. It should be illustrated that, if the position information of a certain target road element corresponding to a certain target load identifier is the same as the original position of the target load identifier, it is determined that the position information of the target road element is an un-deviated position (i.e., a position without deviation) corresponding to the target load identifier; and if the position information of a certain target road element corresponding to a certain target load identifier is different from the original position of the target load identifier, it is determined that the position information of the target road element is a deviated position corresponding to the target load identifier. For any target load identifier, if a proportion of the number of the deviated positions corresponding to the target load identifier to the number of pieces of position information of the target road elements corresponding to the target load identifier is greater than a preset proportion threshold, a to-be-used position corresponding to the target load identifier is determined according to the deviated positions corresponding to the target load identifier. Specifically, an average value of the deviated positions corresponding to the target load identifier may be determined as the to-be-used position corresponding to the target load identifier, but the present disclosure is not limited thereto. The preset proportion threshold may be, but not limited to, 30%, 40%, 50% and so on. Finally, after acquiring the to-be-used position corresponding to a certain target load identifier, the high-precision map is updated using the to-be-used position corresponding to the target load identifier.

In another aspect of the present disclosure, embodiments of the present disclosure provide a storage medium having stored therein programs that, when executed, control a device in which the storage medium is disposed to execute the method for updating a high-precision map as described above.

In another aspect of the present disclosure, embodiments of the present disclosure provide an apparatus for updating a high-precision map. The apparatus includes: a storage medium; and one or more processors coupled to the storage medium. The one or more processors are configured to execute program instructions stored in the storage medium, and the program instructions, when executed, cause the method for updating a high-precision map as described above to be performed.

Further, as implementations of the above methods as shown in FIG. 1 and FIG. 2, other embodiments of the present application also provide an apparatus for updating a high-precision map. Embodiments with respect to the apparatus correspond to above embodiments with respect to the method. For ease of reading, details that have been described in above embodiments with respect to the method will not be elaborated in embodiments with respect to the apparatus, but it is clear to those skilled in the art that the apparatus as described herein is able to realize all the contents as described in above embodiments with respect to the method. The apparatus is applied to reduce the cost for updating the high-precision map, on the basis of ensuring that the positions of the road identifier and lane line in the high-precision map are updated in time. Specifically, as shown in FIG. 3, the apparatus includes an acquiring unit 31, a determining unit 32 and an updating unit 33.

The acquiring unit 31 is configured to acquire running data corresponding to target vehicles. The running data corresponding to the target vehicles is collected by the target vehicles when each of the target vehicle passes through a target road section within a target time period, and the running data corresponding to the target vehicles includes: running route information corresponding to each of the target vehicles, a running video and a camera calibration file corresponding to the target vehicle.

The determining unit 32 is configured to determine position information of target road elements collected by each of the target vehicles according to the running route information, the running video and the camera calibration file corresponding to the target vehicle. The position information of each of the target road elements is position information of a target lane line or a target road identifier in the target road section in the high-precision map.

The updating unit 33 is configured to update the high-precision map according to the position information of the target road elements collected by each of the target vehicles.

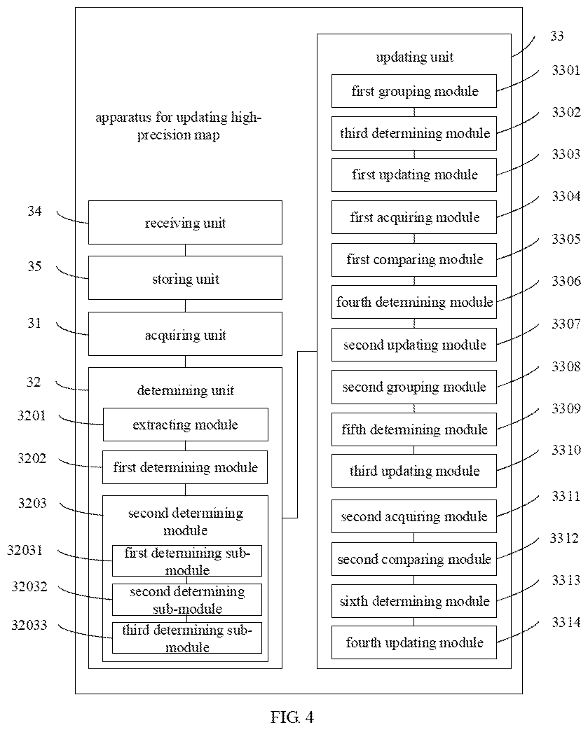

Further, as shown in FIG. 4, the determining unit 32 includes an extracting module 3201, a first determining module 3202, and a second determining module 3203.

The extracting module 3201 is configured to extract frames of running images from the running video corresponding to the target vehicle. Each of the frames of running images includes a target road element, and the target road element is a target lane line or a target road identifier.

The first determining module 3202 is configured to determine position information corresponding to each of the frames of running images according to the running video and the running route information corresponding to the target vehicle. The position information corresponding to each of the frames of running images is position information of the target vehicle in the high-precision map when the target vehicle shoots the running image.

The second determining module 3203 is configured to determine the position information of the target road elements collected by the target vehicle according to the camera calibration file corresponding to the target vehicle, the frames of running images and the position information corresponding to each of the frames of running images.

Further, as shown in FIG. 4, the second determining module 3203 includes: a first determining sub-module 32031, a second determining sub-module 32032, and a third determining sub-module 32033.

The first determining sub-module 32031 is configured to determine a first position corresponding to each of the target road elements according to a preset perceptual recognition algorithm and the frames of running images. The first position corresponding to each of the target road elements is a position of the target road element in the respective running image.

The second determining sub-module 32032 is configured to determine a second position corresponding to each of the target road elements according to the first position corresponding to the target road element and the camera calibration file. The second position corresponding to each of the target road elements is a position of the target road element relative to the target vehicle.

The third determining sub-module 32033 is configured to determine the position information of the target road elements collected by the target vehicle according to the second position corresponding to each of the target road elements and the position information corresponding to each of the frames of running images.

Further, as shown in FIG. 4, the position information of the target road elements collected by each of the target vehicles is position information of target lane lines in the target road section in the high-precision map, and the updating unit 33 includes: a first grouping module 3301, a third determining module 3302, and a first updating module 3303.

The first grouping module 3301 is configured to group position information of target road elements corresponding to each of the target lane lines into sets to gather position information of target road elements at a same position corresponding to the target lane line into a same set.

The third determining module 3302 is configured to determine, from the sets corresponding to each of the target lane lines, position information of target road elements in a set which includes the largest number of set elements as a to-be-used position corresponding to the target lane line.

The first updating module 3303 is configured to update the high-precision map using the to-be-used position corresponding to each of the target lane lines.

Further, as shown in FIG. 4, the position information of the target road elements collected by each of the target vehicles is position information of target lane lines in the target road section in the high-precision map, and the updating unit 33 includes: a first acquiring module 3304, a first comparing module 3305, a fourth determining module 3306, and a second updating module 3307.

The first acquiring module 3304 is configured to acquire an original position of each of the target lane lines from the high-precision map.

The first comparing module 3305 is configured to compare the position information of the target road elements corresponding to each of the target lane lines with the original position of the target lane line to acquire deviated positions corresponding to the target lane line.

The fourth determining module 3306 is configured to determine a to-be-used position corresponding to the target lane line according to the deviated positions corresponding to the target lane line when a proportion of the number of the deviated positions corresponding to the target lane line to the number of pieces of position information of the target road elements corresponding to the target lane line is greater than a preset proportion threshold.

The second updating module 3307 is configured to update the high-precision map using the to-be-used position corresponding to the target lane line.

Further, as shown in FIG. 4, the position information of the target road elements collected by each of the target vehicles is position information of target load identifiers in the target road section in the high-precision map, and the updating unit 33 includes: a second grouping module 3308, a fifth determining module 3309, and a third updating module 3310.

The second grouping module 3308 is configured to group position information of target road elements corresponding to each of the target load identifiers into sets to gather position information of target road elements at a same position corresponding to the target load identifier into a same set.

The fifth determining module 3309 is configured to determine, from the sets corresponding to each of the target load identifiers, position information of target road elements in a set which includes the largest number of set elements as a to-be-used position corresponding to the target load identifier.

The third updating module 3310 is configured to update the high-precision map using the to-be-used position corresponding to each of the target load identifiers.

Further, as shown in FIG. 4, the position information of the target road elements collected by each of the target vehicles is position information of target road identifiers in the target road section in the high-precision map, and the updating unit 33 includes: a second acquiring module 3311, a second comparing module 3312, a sixth determining module 3313, and a fourth updating module 3314.

The second acquiring module 3311 is configured to acquire an original position of each of the target road identifiers from the high-precision map.

The second comparing module 3312 is configured to compare the position information of the target road elements corresponding to each of the target road identifiers with the original position of the target road identifier to acquire deviated positions corresponding to the target road identifier.

The sixth determining module 3313 is configured to determine a to-be-used position corresponding to the target road identifier according to the deviated positions corresponding to the target road identifier when a proportion of the number of the deviated positions corresponding to the target road identifier to the number of pieces of position information of the target road elements corresponding to the target road identifier is greater than a preset proportion threshold.

The fourth updating module 3314 is configured to update the high-precision map using the to-be-used position corresponding to the target road identifier.

Further, as shown in FIG. 4, the apparatus further includes: a receiving unit 34 and a storing unit 35.

The receiving unit 34 is configured to receive running data sent by each of the target vehicles before the acquiring unit 31 acquires the running data corresponding to the target vehicles.

The storing unit 35 is configured to store the running data sent by each of the target vehicles into a local storage space.

Further, as shown in FIG. 4, each of the target vehicles is an ordinary vehicle provided with a preset camera and a GPS sensor.

Embodiments of the present disclosure provide a method and apparatus for updating a high-precision map. In contrast to updating positions of road identifies and lane lines in a high-precision map by a centralized drawing method in the related art, embodiments of the present disclosure are able to acquire, at a cloud server, the running data (including such as the running videos shot by preset the cameras, the running route information recorded by the GPS sensors, and the camera calibration files corresponding to the respective preset cameras) collected by the target vehicles when each of the target vehicle passes through the target road section within the target time period; determine by the cloud server the position information of target road elements corresponding to each target lane line and/or each target load identifier collected by each of the target vehicles according to the running route information, the running video and the camera calibration file collected by the target vehicle; and update by the cloud server the high-precision map according to the position information of the target road elements corresponding to each target lane line and/or each target load identifier collected by each of the target vehicles. Since each target vehicle is an ordinary vehicle equipped with a preset camera and a GPS sensor, and the target vehicle, after collecting the running data, will upload the running data to the cloud server, the cloud server can ensure that the positions of the road identifier and the lane line in the high-precision map are updated in time, and at the same time, the cost for updating the high-precision map is reduced.

The apparatus for updating a high-precision map includes a memory and a processor. The above acquiring unit, the determining unit and the updating unit are stored in the memory as program units, and the processor is configured to execute the program units stored in the memory to realize the corresponding functions.

The processor includes a kernel, which is configured to call a program unit from the memory. The processor may include one or more kernels. By adjusting parameters of the kernel, it can be ensured that the positions of the road identifier and the lane line in the high-precision map are updated in time, and at the same time, the cost for updating the high-precision map is reduced.

Embodiments of the present disclosure provide a storage medium having stored therein instructions that, when executed, control a device in which the storage medium is disposed to execute the method for updating a high-precision map as described hereinbefore.

The storage medium may include a non-permanent memory, a random-access memory (RAM) and/or a nonvolatile memory and other forms of computer-readable mediums, such as a read-only memory (ROM) or a flash memory (such as a flash RAM), and the memory includes at least one storage chip.

Embodiments of the present disclosure further provide an apparatus for updating a high-precision map, which includes: a storage medium; and one or more processors coupled to the storage medium. The one or more processors are configured to execute program instructions stored in the storage medium, and the program instructions, when executed, cause the method for updating a high-precision map as described hereinbefore to be performed.

Embodiments of the present disclosure provide a device. The device includes a processor, a memory and a program stored in the memory and executable by the processor. The processor, when executes the program, causes the following steps to be achieved:

acquiring running data corresponding to target vehicles, in which the running data corresponding to the target vehicles is collected by the target vehicles when each of the target vehicle passes through a target road section within a target time period, and the running data corresponding to the target vehicles comprises: running route information corresponding to each of the target vehicles, a running video and a camera calibration file corresponding to the target vehicle;

determining position information of target road elements collected by each of the target vehicles according to the running route information, the running video and the camera calibration file corresponding to the target vehicle, in which the position information of each of the target road elements is position information of a target lane line or a target road identifier in the target road section in the high-precision map; and

updating the high-precision map according to the position information of the target road elements collected by each of the target vehicles.

Further, the determining the position information of the target road elements collected by each of the target vehicles according to the running route information, the running video and the camera calibration file corresponding to the target vehicle includes:

extracting frames of running images from the running video corresponding to the target vehicle, in which each of the frames of running images includes a target road element, and the target road element is a target lane line or a target road identifier;

determining position information corresponding to each of the frames of running images according to the running video and the running route information corresponding to the target vehicle, in which the position information corresponding to each of the frames of running images is position information of the target vehicle in the high-precision map when the target vehicle shoots the running image; and

determining the position information of the target road elements collected by the target vehicle according to the camera calibration file corresponding to the target vehicle, the frames of running images and the position information corresponding to each of the frames of running images.

Further, the determining the position information of the target road elements collected by the target vehicle according to the camera calibration file corresponding to the target vehicle, the frames of running images and the position information corresponding to each of the frames of running images includes:

determining a first position corresponding to each of the target road elements according to a preset perceptual recognition algorithm and the frames of running images, in which the first position corresponding to each of the target road elements is a position of the target road element in the respective running image;

determining a second position corresponding to each of the target road elements according to the first position corresponding to the target road element and the camera calibration file, in which the second position corresponding to each of the target road elements is a position of the target road element relative to the target vehicle; and

determining the position information of the target road elements collected by the target vehicle according to the second position corresponding to each of the target road elements and the position information corresponding to each of the frames of running images.

Further, the position information of the target road elements collected by each of the target vehicles is position information of target lane lines in the target road section in the high-precision map, and the updating the high-precision map according to the position information of the target road elements collected by each of the target vehicles includes:

grouping position information of target road elements corresponding to each of the target lane lines into sets to gather position information of target road elements at a same position corresponding to the target lane line into a same set;

determining, from the sets corresponding to each of the target lane lines, position information of target road elements in a set which includes the largest number of set elements as a to-be-used position corresponding to the target lane line; and

updating the high-precision map using the to-be-used position corresponding to each of the target lane lines.

Further, the position information of the target road elements collected by each of the target vehicles is position information of target lane lines in the target road section in the high-precision map, and the updating the high-precision map according to the position information of the target road elements collected by each of the target vehicles includes:

acquiring an original position of each of the target lane lines from the high-precision map; comparing the position information of the target road elements corresponding to each of the target lane lines with the original position of the target lane line to acquire deviated positions corresponding to the target lane line;

determining a to-be-used position corresponding to the target lane line according to the deviated positions corresponding to the target lane line when a proportion of the number of the deviated positions corresponding to the target lane line to the number of pieces of position information of the target road elements corresponding to the target lane line is greater than a preset proportion threshold; and

updating the high-precision map using the to-be-used position corresponding to the target lane line.

Further, the position information of the target road elements collected by each of the target vehicles is position information of target load identifiers in the target road section in the high-precision map, and the updating the high-precision map according to the position information of the target road elements collected by each of the target vehicles includes:

grouping position information of target road elements corresponding to each of the target load identifiers into sets to gather position information of target road elements at a same position corresponding to the target load identifier into a same set;

determining, from the sets corresponding to each of the target load identifiers, position information of target road elements in a set which includes the largest number of set elements as a to-be-used position corresponding to the target load identifier; and

updating the high-precision map using the to-be-used position corresponding to each of the target load identifiers.

Further, the position information of the target road elements collected by each of the target vehicles is position information of target road identifiers in the target road section in the high-precision map, and the updating the high-precision map according to the position information of the target road elements collected by each of the target vehicles includes:

acquiring an original position of each of the target road identifiers from the high-precision map;

comparing the position information of the target road elements corresponding to each of the target road identifiers with the original position of the target road identifier to acquire deviated positions corresponding to the target road identifier;

determining a to-be-used position corresponding to the target road identifier according to the deviated positions corresponding to the target road identifier when a proportion of the number of the deviated positions corresponding to the target road identifier to the number of pieces of position information of the target road elements corresponding to the target road identifier is greater than a preset proportion threshold; and

updating the high-precision map using the to-be-used position corresponding to the target road identifier.

Further, before acquiring the running data corresponding to the target vehicles, the method further includes:

receiving running data sent by each of the target vehicles; and

storing the running data sent by each of the target vehicles into a local storage space.

Further, each of the target vehicles is provided with a preset camera and a GPS sensor.

Embodiments of the present disclosure further provide a computer program product that, when executed on a data processing device, is suitable for executing program codes that are initialized with the following method steps: acquiring running data corresponding to target vehicles, in which the running data corresponding to the target vehicles is collected by the target vehicles when each of the target vehicle passes through a target road section within a target time period, and the running data corresponding to the target vehicles comprises: running route information corresponding to each of the target vehicles, a running video and a camera calibration file corresponding to the target vehicle; determining position information of target road elements collected by each of the target vehicles according to the running route information, the running video and the camera calibration file corresponding to the target vehicle, in which the position information of each of the target road elements is position information of a target lane line or a target road identifier in the target road section in the high-precision map; and updating the high-precision map according to the position information of the target road elements collected by each of the target vehicles.

It will be understood by those skilled in the art that embodiments of the present disclosure may be provided as methods, systems, or computer program products. Therefore, embodiments of the present disclosure may be implemented in a form of hardware, software or a combination thereof. Moreover, embodiments of the present disclosure may adopt a form of the computer program product executable on one or more computer available storage mediums (including but not limited to disk memories, CD-ROMs, optical memories, etc.) contained therein computer available program code.

The present disclosure is described with reference to the flowcharts and/or block diagrams of the method, device (system) and computer program product according to embodiments of the present disclosure. It should be understood that each process and/or block in the flowcharts and/or block diagrams as well as any combination of processes and/or blocks in the flowcharts and/or block diagrams may be realized by computer program instructions. A processor from these computer program instructions to a general-purpose computer, a special-purpose computer, an embedded processing machine or other programmable data processing devices may be provided to generate a machine, so that an apparatus for realizing one or more functions specified in one or more processes in the flowcharts and/or one or more blocks in the block diagrams is generated through the instructions executed by the processor of the computers or other programmable data processing devices.

These computer program instructions may also be stored in a computer-readable memory that can guide the computer or other programmable data processing device to work in a specific way, so that the instructions stored in the computer-readable memory form a manufactured product including an instruction device, which implements the one or more functions specified in one or more processes in the flowcharts and/or one or more blocks in the block diagrams.

These computer program instructions may also be loaded on a computer or other programmable data processing device, so that a series of operation steps are performed on the computer or other programmable device to produce computer implemented processing, so that the instructions executed on the computer or other programmable device provide steps for realizing the one or more functions specified in one or more processes of the flowchart and/or one or more blocks in the block diagrams.

In a typical configuration, a computing device includes one or more processors (CPUs), input/output interfaces, a network interface, and a memory.

The memory may include a non-permanent memory, a random-access memory (RAM) and/or a nonvolatile memory and other forms of computer-readable mediums, such as a read-only memory (ROM) or a flash memory (such as a flash RAM). The memory is an example of the computer-readable medium.

The computer-readable medium includes permanent and non-permanent, removable and non-removable media, which may realize information storage by any method or technology. The information may be computer-readable instructions, data structures, modules of programs or other data. Examples of the computer storage medium include, but are not limited to, phase-change memory (such as a parallel random access machine, PRAM), a static random access memory (SRAM), a dynamic random access memory (DRAM), other types of random access memory (RAMs), a read-only memory (ROM), an electrically erasable programmable read-only memory (EEPROM), a flash memory or other memory technology, a portable compact disk read-only memory (CD-ROM), a digital versatile disc (DVD) or other optical storage, a cartridge-form magnetic tape, a magnetic tape, a magnetic disk storage or other magnetic storage devices or any other non-transmission medium, which may be used to store information that is accessible by a computing device. As defined herein, the computer-readable medium does not include temporary computer-readable media (transitory media), such as modulated data signals and carriers.

Also, it should be noted that the terms like “comprise”, “include” or any other variations thereof are intended to cover non-exclusive inclusion, so that a process, method, commodity or device including a series of elements includes not only those elements, but also other elements not explicitly listed, or elements inherent in such process, method, commodity or device. In the absence of more restrictions, elements defined by the statement “including a . . . ” do not exclude the existence of other identical elements in the process, method, commodity or device including these elements.

It will be understood by those skilled in the art that embodiments of the present disclosure may be provided as methods, systems, or computer program products. Therefore, embodiments of the present disclosure may be implemented in a form of hardware, software or a combination thereof. Moreover, embodiments of the present disclosure may adopt a form of the computer program product executable on one or more computer available storage mediums (including but not limited to disk memories, CD-ROMs, optical memories, etc.) contained therein computer available program code.

The above-described embodiments are only examples of the present disclosure, which shall not be construed to limit the present disclosure. It will be appreciated by those skilled in the art that, the present disclosure may cover various changes and modifications, and any modifications, equivalents, improvements made within the spirit and principle of the present disclosure shall be included in the scope of the present disclosure as defined in claims.

1. A method for updating a high-precision map, comprising:
acquiring running data corresponding to target vehicles, wherein the running data corresponding to the target vehicles is collected by the target vehicles when each of the target vehicle passes through a target road section within a target time period, and the running data corresponding to the target vehicles comprises: running route information corresponding to each of the target vehicles, a running video and a camera calibration file corresponding to the target vehicle;
determining position information of target road elements collected by each of the target vehicles according to the running route information, the running video and the camera calibration file corresponding to the target vehicle, wherein the position information of each of the target road elements is position information of a target lane line or a target road identifier in the target road section in the high-precision map; and
updating the high-precision map according to the position information of the target road elements collected by each of the target vehicles.

2. The method according to claim 1, wherein the determining the position information of the target road elements collected by each of the target vehicles according to the running route information, the running video and the camera calibration file corresponding to the target vehicle comprises:
extracting frames of running images from the running video corresponding to the target vehicle, wherein each of the frames of running images comprises a target road element, and the target road element is a target lane line or a target road identifier;
determining position information corresponding to each of the frames of running images according to the running video and the running route information corresponding to the target vehicle, wherein the position information corresponding to each of the frames of running images is position information of the target vehicle in the high-precision map when the target vehicle shoots the running image; and
determining the position information of the target road elements collected by the target vehicle according to the camera calibration file corresponding to the target vehicle, the frames of running images and the position information corresponding to each of the frames of running images.

3. The method according to claim 2, wherein the determining the position information of the target road elements collected by the target vehicle according to the camera calibration file corresponding to the target vehicle, the frames of running images and the position information corresponding to each of the frames of running images comprises:
determining a first position corresponding to each of the target road elements according to a preset perceptual recognition algorithm and the frames of running images, wherein the first position corresponding to each of the target road elements is a position of the target road element in the respective running image;
determining a second position corresponding to each of the target road elements according to the first position corresponding to the target road element and the camera calibration file, wherein the second position corresponding to each of the target road elements is a position of the target road element relative to the target vehicle; and
determining the position information of the target road elements collected by the target vehicle according to the second position corresponding to each of the target road elements and the position information corresponding to each of the frames of running images.

4. The method according to claim 1, wherein the position information of the target road elements collected by each of the target vehicles is position information of target lane lines in the target road section in the high-precision map, and the updating the high-precision map according to the position information of the target road elements collected by each of the target vehicles comprises:
grouping position information of target road elements corresponding to each of the target lane lines into sets to gather position information of target road elements at a same position corresponding to the target lane line into a same set;
determining, from the sets corresponding to each of the target lane lines, position information of target road elements in a set which includes the largest number of set elements as a to-be-used position corresponding to the target lane line; and
updating the high-precision map using the to-be-used position corresponding to each of the target lane lines.

5. The method according to claim 1, wherein the position information of the target road elements collected by each of the target vehicles is position information of target lane lines in the target road section in the high-precision map, and the updating the high-precision map according to the position information of the target road elements collected by each of the target vehicles comprises:
acquiring an original position of each of the target lane lines from the high-precision map;
comparing the position information of the target road elements corresponding to each of the target lane lines with the original position of the target lane line to acquire deviated positions corresponding to the target lane line;
determining a to-be-used position corresponding to the target lane line according to the deviated positions corresponding to the target lane line when a proportion of the number of the deviated positions corresponding to the target lane line to the number of pieces of position information of the target road elements corresponding to the target lane line is greater than a preset proportion threshold; and
updating the high-precision map using the to-be-used position corresponding to the target lane line.

6. The method according to claim 1, wherein the position information of the target road elements collected by each of the target vehicles is position information of target load identifiers in the target road section in the high-precision map, and the updating the high-precision map according to the position information of the target road elements collected by each of the target vehicles comprises:
grouping position information of target road elements corresponding to each of the target load identifiers into sets to gather position information of target road elements at a same position corresponding to the target load identifier into a same set;
determining, from the sets corresponding to each of the target load identifiers, position information of target road elements in a set which includes the largest number of set elements as a to-be-used position corresponding to the target load identifier; and
updating the high-precision map using the to-be-used position corresponding to each of the target load identifiers.

7. The method according to claim 1, wherein the position information of the target road elements collected by each of the target vehicles is position information of target road identifiers in the target road section in the high-precision map, and the updating the high-precision map according to the position information of the target road elements collected by each of the target vehicles comprises:
acquiring an original position of each of the target road identifiers from the high-precision map;
comparing the position information of the target road elements corresponding to each of the target road identifiers with the original position of the target road identifier to acquire deviated positions corresponding to the target road identifier;
determining a to-be-used position corresponding to the target road identifier according to the deviated positions corresponding to the target road identifier when a proportion of the number of the deviated positions corresponding to the target road identifier to the number of pieces of position information of the target road elements corresponding to the target road identifier is greater than a preset proportion threshold; and
updating the high-precision map using the to-be-used position corresponding to the target road identifier.

8. The method according to claim 1, wherein before acquiring the running data corresponding to the target vehicles, the method further comprises:
receiving running data sent by each of the target vehicles; and
storing the running data sent by each of the target vehicles into a local storage space.

9. The method according to 1, wherein each of the target vehicles is provided with a preset camera and a GPS sensor.

10-14. (canceled)

15. A storage medium having stored therein programs that, when executed, control a device in which the storage medium is disposed to execute a method for updating a high-precision map including:
acquiring running data corresponding to target vehicles, wherein the running data corresponding to the target vehicles is collected by the target vehicles when each of the target vehicle passes through a target road section within a target time period, and the running data corresponding to the target vehicles comprises: running route information corresponding to each of the target vehicles, a running video and a camera calibration file corresponding to the target vehicle;
determining position information of target road elements collected by each of the target vehicles according to the running route information, the running video and the camera calibration file corresponding to the target vehicle, wherein the position information of each of the target road elements is position information of a target lane line or a target road identifier in the target road section in the high-precision map; and
updating the high-precision map according to the position information of the target road elements collected by each of the target vehicles.

16. An apparatus for updating a high-precision map, comprising:
a storage medium; and
one or more processors, coupled to the storage medium,
wherein the one or more processors are configured to execute program instructions stored in the storage medium, and the program instructions, when executed, cause a method for updating a high-precision map to be performed,
wherein the method includes:
acquiring running data corresponding to target vehicles, wherein the running data corresponding to the target vehicles is collected by the target vehicles when each of the target vehicle passes through a target road section within a target time period, and the running data corresponding to the target vehicles comprises: running route information corresponding to each of the target vehicles, a running video and a camera calibration file corresponding to the target vehicle;
determining position information of target road elements collected by each of the target vehicles according to the running route information, the running video and the camera calibration file corresponding to the target vehicle, wherein the position information of each of the target road elements is position information of a target lane line or a target road identifier in the target road section in the high-precision map; and
updating the high-precision map according to the position information of the target road elements collected by each of the target vehicles.

17. The apparatus according to claim 16, wherein the determining the position information of the target road elements collected by each of the target vehicles according to the running route information, the running video and the camera calibration file corresponding to the target vehicle comprises:
extracting frames of running images from the running video corresponding to the target vehicle, wherein each of the frames of running images comprises a target road element, and the target road element is a target lane line or a target road identifier;
determining position information corresponding to each of the frames of running images according to the running video and the running route information corresponding to the target vehicle, wherein the position information corresponding to each of the frames of running images is position information of the target vehicle in the high-precision map when the target vehicle shoots the running image; and
determining the position information of the target road elements collected by the target vehicle according to the camera calibration file corresponding to the target vehicle, the frames of running images and the position information corresponding to each of the frames of running images.

18. The apparatus according to claim 17, wherein the determining the position information of the target road elements collected by the target vehicle according to the camera calibration file corresponding to the target vehicle, the frames of running images and the position information corresponding to each of the frames of running images comprises:
determining a first position corresponding to each of the target road elements according to a preset perceptual recognition algorithm and the frames of running images, wherein the first position corresponding to each of the target road elements is a position of the target road element in the respective running image;
determining a second position corresponding to each of the target road elements according to the first position corresponding to the target road element and the camera calibration file, wherein the second position corresponding to each of the target road elements is a position of the target road element relative to the target vehicle; and
determining the position information of the target road elements collected by the target vehicle according to the second position corresponding to each of the target road elements and the position information corresponding to each of the frames of running images.

19. The apparatus according to claim 16, wherein the position information of the target road elements collected by each of the target vehicles is position information of target lane lines in the target road section in the high-precision map, and the updating the high-precision map according to the position information of the target road elements collected by each of the target vehicles comprises:
grouping position information of target road elements corresponding to each of the target lane lines into sets to gather position information of target road elements at a same position corresponding to the target lane line into a same set;
determining, from the sets corresponding to each of the target lane lines, position information of target road elements in a set which includes the largest number of set elements as a to-be-used position corresponding to the target lane line; and
updating the high-precision map using the to-be-used position corresponding to each of the target lane lines.

20. The apparatus according to claim 16, wherein the position information of the target road elements collected by each of the target vehicles is position information of target lane lines in the target road section in the high-precision map, and the updating the high-precision map according to the position information of the target road elements collected by each of the target vehicles comprises:
acquiring an original position of each of the target lane lines from the high-precision map;
comparing the position information of the target road elements corresponding to each of the target lane lines with the original position of the target lane line to acquire deviated positions corresponding to the target lane line;
determining a to-be-used position corresponding to the target lane line according to the deviated positions corresponding to the target lane line when a proportion of the number of the deviated positions corresponding to the target lane line to the number of pieces of position information of the target road elements corresponding to the target lane line is greater than a preset proportion threshold; and
updating the high-precision map using the to-be-used position corresponding to the target lane line.

21. The apparatus according to claim 16, wherein the position information of the target road elements collected by each of the target vehicles is position information of target load identifiers in the target road section in the high-precision map, and the updating the high-precision map according to the position information of the target road elements collected by each of the target vehicles comprises:
grouping position information of target road elements corresponding to each of the target load identifiers into sets to gather position information of target road elements at a same position corresponding to the target load identifier into a same set;
determining, from the sets corresponding to each of the target load identifiers, position information of target road elements in a set which includes the largest number of set elements as a to-be-used position corresponding to the target load identifier; and
updating the high-precision map using the to-be-used position corresponding to each of the target load identifiers.

22. The apparatus according to claim 16, wherein the position information of the target road elements collected by each of the target vehicles is position information of target road identifiers in the target road section in the high-precision map, and the updating the high-precision map according to the position information of the target road elements collected by each of the target vehicles comprises:
acquiring an original position of each of the target road identifiers from the high-precision map;
comparing the position information of the target road elements corresponding to each of the target road identifiers with the original position of the target road identifier to acquire deviated positions corresponding to the target road identifier;
determining a to-be-used position corresponding to the target road identifier according to the deviated positions corresponding to the target road identifier when a proportion of the number of the deviated positions corresponding to the target road identifier to the number of pieces of position information of the target road elements corresponding to the target road identifier is greater than a preset proportion threshold; and
updating the high-precision map using the to-be-used position corresponding to the target road identifier.

23. The apparatus according to claim 16, wherein before acquiring the running data corresponding to the target vehicles, the method further comprises:
receiving running data sent by each of the target vehicles; and
storing the running data sent by each of the target vehicles into a local storage space.

24. The storage medium according to claim 15, wherein the determining the position information of the target road elements collected by each of the target vehicles according to the running route information, the running video and the camera calibration file corresponding to the target vehicle comprises:
extracting frames of running images from the running video corresponding to the target vehicle, wherein each of the frames of running images comprises a target road element, and the target road element is a target lane line or a target road identifier;
determining position information corresponding to each of the frames of running images according to the running video and the running route information corresponding to the target vehicle, wherein the position information corresponding to each of the frames of running images is position information of the target vehicle in the high-precision map when the target vehicle shoots the running image; and
determining the position information of the target road elements collected by the target vehicle according to the camera calibration file corresponding to the target vehicle, the frames of running images and the position information corresponding to each of the frames of running images.

25. The storage medium according to claim 24, wherein the determining the position information of the target road elements collected by the target vehicle according to the camera calibration file corresponding to the target vehicle, the frames of running images and the position information corresponding to each of the frames of running images comprises:
determining a first position corresponding to each of the target road elements according to a preset perceptual recognition algorithm and the frames of running images, wherein the first position corresponding to each of the target road elements is a position of the target road element in the respective running image;
determining a second position corresponding to each of the target road elements according to the first position corresponding to the target road element and the camera calibration file, wherein the second position corresponding to each of the target road elements is a position of the target road element relative to the target vehicle; and
determining the position information of the target road elements collected by the target vehicle according to the second position corresponding to each of the target road elements and the position information corresponding to each of the frames of running images.
